(19) United States
(12) Patent Application Publication
(10) Pub. No.: US 2010/0332568 A1
(43) Pub. Date: Dec. 30, 2010

(54) Media Playlists

(76) Inventors: Andrew James Morrison, Woodinville, WA (US); Rodrigo M. Bomfim, Renton, WA (US); Joshuah Vincent, Seattle, WA (US); Patrick N. Nelson, Seattle, WA (US); Christopher B. Weare, Bellevue, WA (US)

Correspondence Address: MICROSOFT CORPORATION, ONE MICROSOFT WAY, REDMOND, WA, 98052, US

(21) Appl. No.: 12/492,756

(22) Filed: Jun. 26, 2009

(51) Int. Cl. G06F 15/16; G06F 17/30

(52) U.S. Cl. 707/912; 709/219; 707/955; 707/957

(57) ABSTRACT

Media playlist techniques are described. In an implementation, a communication is formed, for transmission via a network to a media provider, to request data that describes media that is available for streaming from the media provider. The playlist is created based at least in part on media that is available locally on the computer and the data received from the media provider such that the playlist references one or more of the media that are available for streaming from the media provider.

### BACKGROUND

Computers may include a vast amount of media. For example, a user may interact with the computer to access websites to purchase and download music, movies, “audio books,” and so on. Through this and other interaction, a user may use the computer to compile thousands of items of media for later playback. For instance, it is not uncommon for users to store thousands and even tens of thousands of songs on the computer.

Because such a vast amount of music may be stored on the computer, however, it may be difficult to locate particular music of interest. Therefore, a user typically interacts with a limited subset of the vast amount of music that is available to the user. Consequently, the user thereby forgoes a majority of the enjoyment that may be available if the user could locate music of interest using conventional media interaction techniques.

### SUMMARY

Media playlist techniques are described. In an implementation, a communication is formed, for transmission via a network to a media provider, to request data that describes media that is available for streaming from the media provider. The playlist is created based at least in part on media that is available locally on the computer and the data received from the media provider such that the playlist references one or more of the media that are available for streaming from the media provider.

In an implementation, a method that is implemented by one or more computers of a media provider includes receiving a communication via a network from a computer. Responsive to the communication, sending data to the computer that references media that is available for streaming to the computer for use in creating a playlist by the computer that references media that is available for streaming via the network to the computer from the media provider.

In an implementation, one or more computer-readable storage media comprise instructions that are executable on a computer to create a playlist based on media that is available locally at the computer and that includes media that is not available locally on the computer but is available to the computer remotely via a network connection and cause the playlist to be output by the computer so the media in the playlist that is not available locally on the computer is streamed to the computer via the network connection.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ media techniques described herein.

FIG. 2 is an illustration of a system in an example implementation in which a seed module of FIG. 1 is shown in greater detail.

FIG. 3 is an illustration of a system in an example implementation in which a recommendation module of FIG. 1 is shown in greater detail.

FIG. 4 is an illustration of a system in an example implementation in which a user interface is used to configure which similarity functions are employed by the recommendation module of FIG. 3.

FIG. 5 is a flow diagram depicting a procedure in an example implementation in which pre-processing is performed to form groups that may serve as a basis for making media recommendations.

FIG. 6 is a flow diagram depicting a procedure in an example implementation in which a seed is formed from data cached using the procedure of FIG. 5.

FIG. 7 is a flow diagram depicting a procedure in an example implementation in which a playlist is formed using a framework of FIGS. 3 and 4.

FIG. 8 is a flow diagram depicting a procedure in an example implementation in which a media playlist is generated to reference media that is local and remote to a computer.

FIG. 9 is an illustration of a system in an example implementation in which the mobile media device of FIG. 1 is illustrated as outputting a playlist that references local and remote media.

### DETAILED DESCRIPTION

Overview

There is a vast amount of media functionality available to users of a computer. However, the sheer amount of media that may be stored using a computer may make it difficult if not impossible to locate particular media of interest. Due to the difficulty of using conventional techniques to locate media that is likely to be of interest to the user, for example, a user may have access to thousands of songs but interact with a limited subset of these songs. Consequently, the user's experience in interacting with media may be frustrating and difficult using conventional techniques.

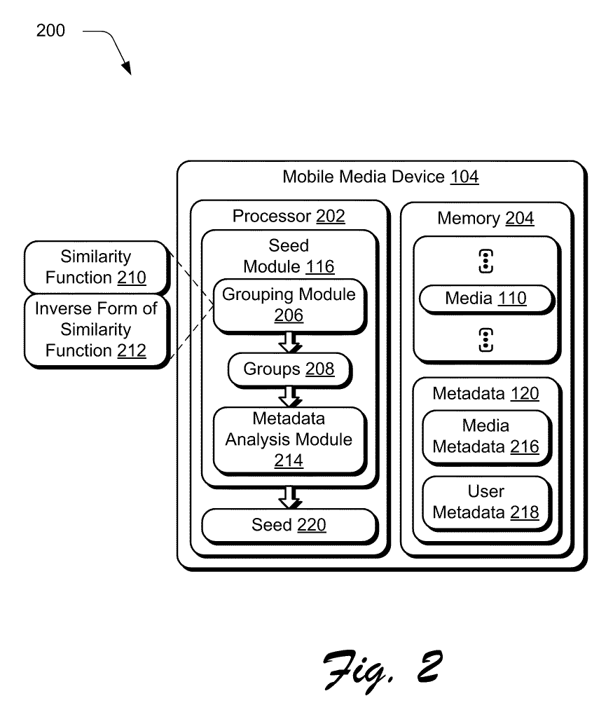

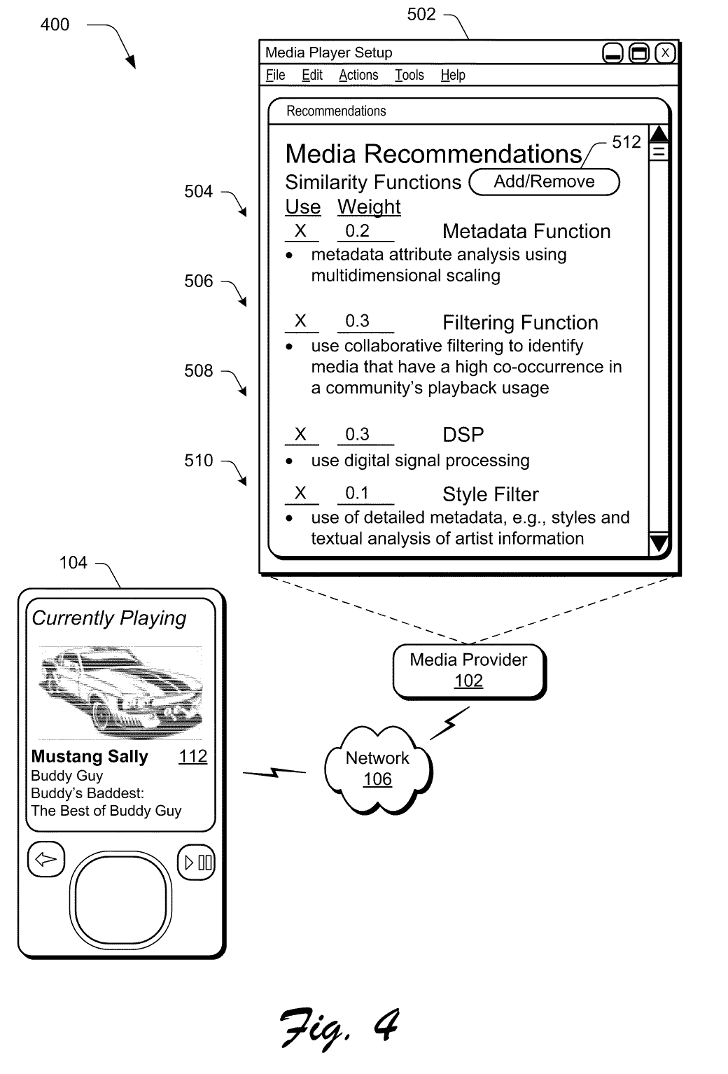

Media seed suggestion and recommendation techniques are described. In an implementation, techniques are described in which a media seed suggestion is generated at least in part based on determining which media are dissimilar to each other. For example, groups of media may be identified using an inverse form of a similarity function to determine which media are dissimilar, one to another. A “seed” may then be selected from the group that is to be used as a basis for generating a playlist. The seed may be selected in a variety of ways, such as based on metadata that describes the media and/or usage of the media, a time of day, and so on. Further discussion of media seed suggestion may be found in relation to FIGS. 2 and 4.

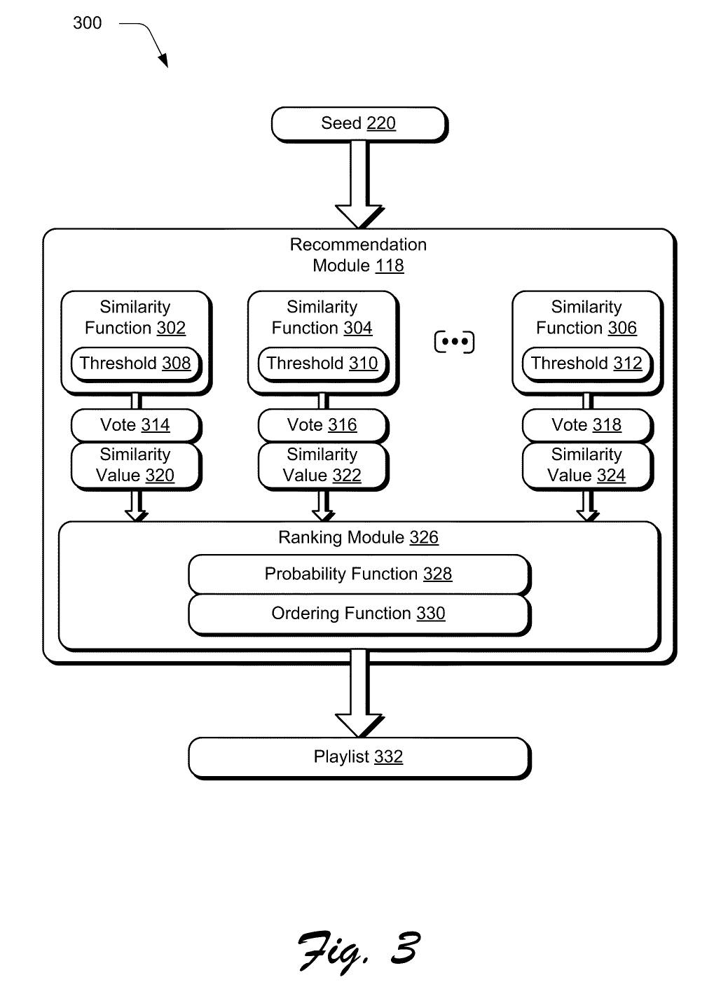

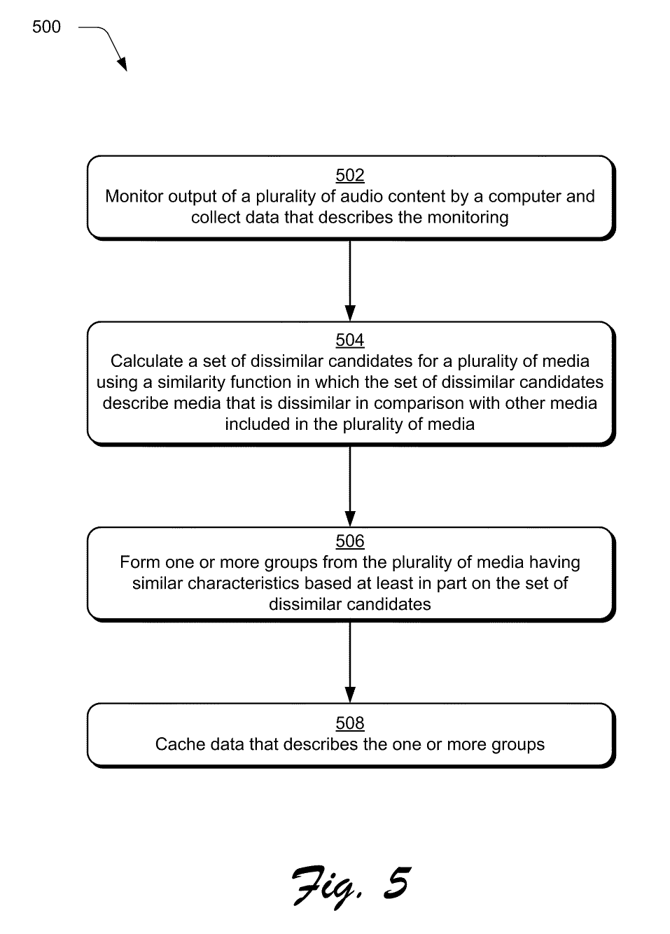

Additionally, techniques are described to form one or more recommendations, such as from the media seed suggestion above. For example, a framework may be implemented that is configured to leverage a variety of different similarity functions to arrive at recommendations of media for output, such as a playlist of media. The framework may be configured in a variety of ways, such as to leverage a voting technique such that the advantages of the different similarity functions may be utilized without having undue influence of one of the similarity functions on the overall result. The framework may also leverage numerical values calculated by the similarity functions for ranking media based on similarity. For instance, the numerical values may be weighted to arrive at a final ranking of the media, one to another. Further discussion of media recommendation techniques may be found in relation to FIGS. 3 and 5.

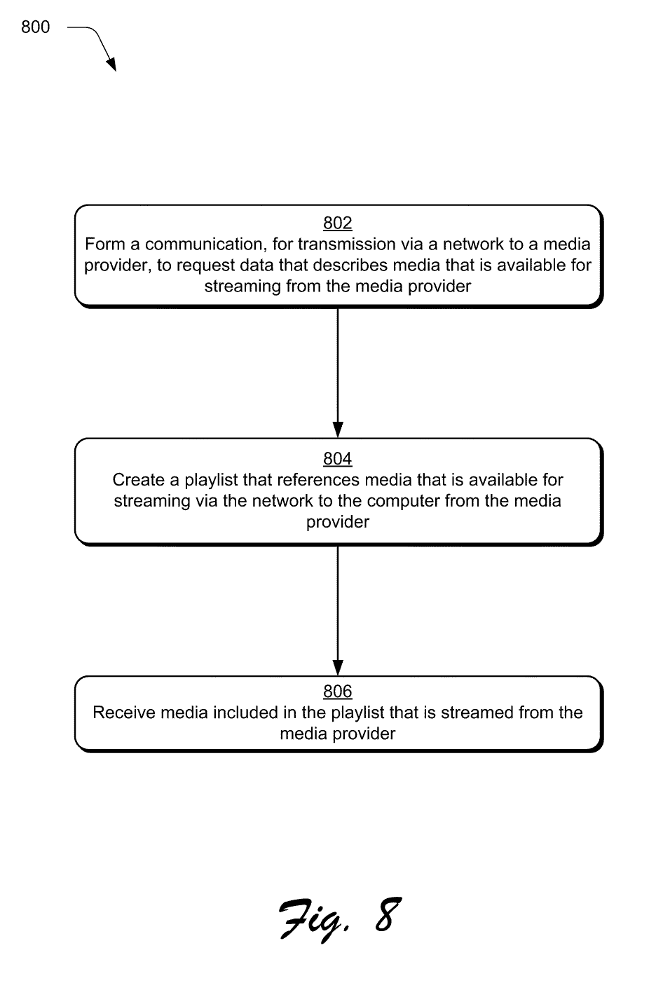

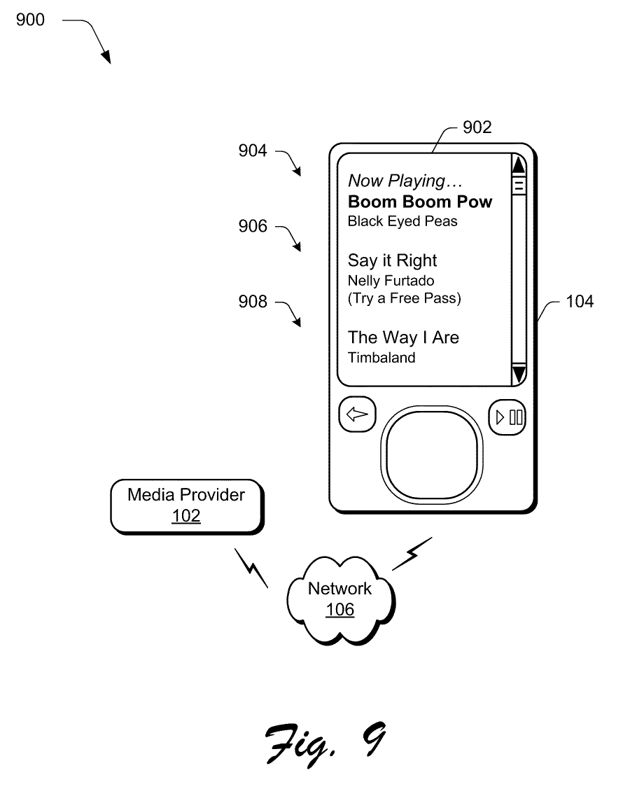

Media playlist techniques are also described. In an implementation, a playlist is created that leverages media that is available locally on a computer as well as media that is available remotely to the computer, e.g., via streaming over a network connection. For instance, a user may select a particular item of media as a seed to generate the playlist, which may be local on the computer and/or remote over a network from a media provider. The playlist may then be created to reference media from both sources, further discussion of which may be found in relation to FIGS. 8 and 9.

In the following discussion, a mobile media device is described that may receive audio content wirelessly from a variety of different sources, which may be stored locally on the mobile media device. However, it should be readily apparent that the following discussion is not to be limited to a mobile media device, audio content, or wireless communication and therefore a wide variety of computers are contemplated. Thus, a variety of different devices may employ the techniques described herein without departing from the spirit and scope thereof, such as other computers such as desktop PCs, netbooks, wireless phones, personal digital assistants, and so on.

Example Environment

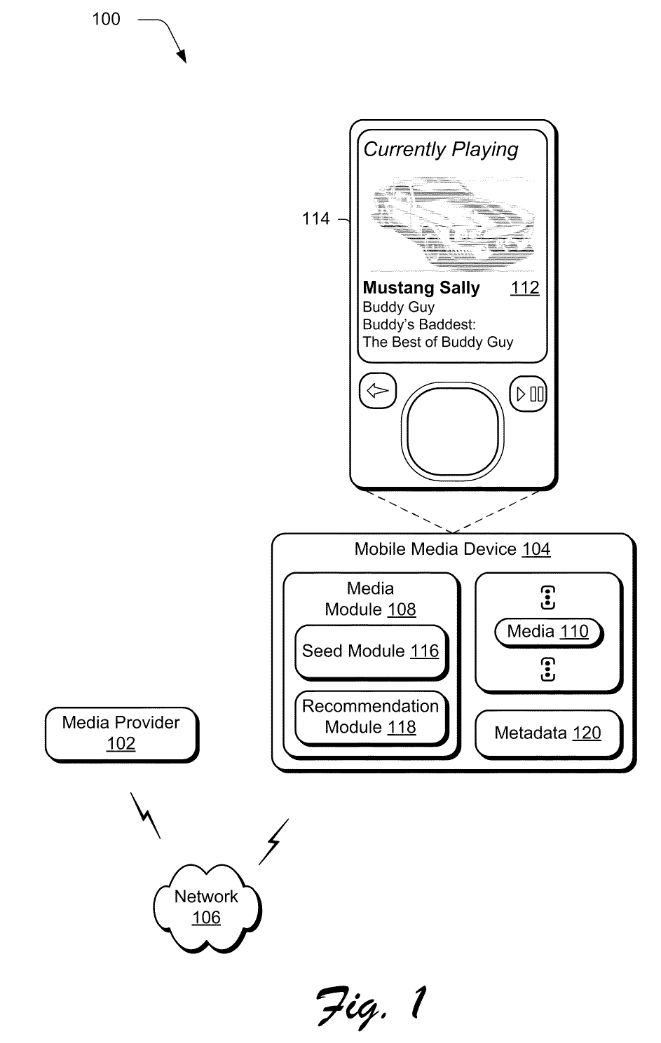

FIG. 1 is an illustration of an environment 100 in an example implementation that is operable to employ media techniques described herein. The illustrated environment 100 includes a media provider 102 that is communicatively coupled to a mobile media device 104 via a network 106. The mobile media device 104 is but one example of a computer that may be configured in a variety of ways. For example, a media module 108 of the media device 104 may include communication functionality to receive media via the network 106 and store it as media 110. The media 110 may also be obtained in a variety of other ways, such as via a local connection with another computer (e.g., wired connection with a desktop PC to “rip” music, another mobile media device via a wireless connection, and so on).

The illustrated media module 108 may also be representative of functionality of the mobile media device 104 to generate and maintain a user interface 112 for display on a display device 114 of the mobile media device 104. The user interface 112 may be configured in a variety of ways, such as to display media that is currently being played by the mobile media device 104 using functionality of the media module 108.

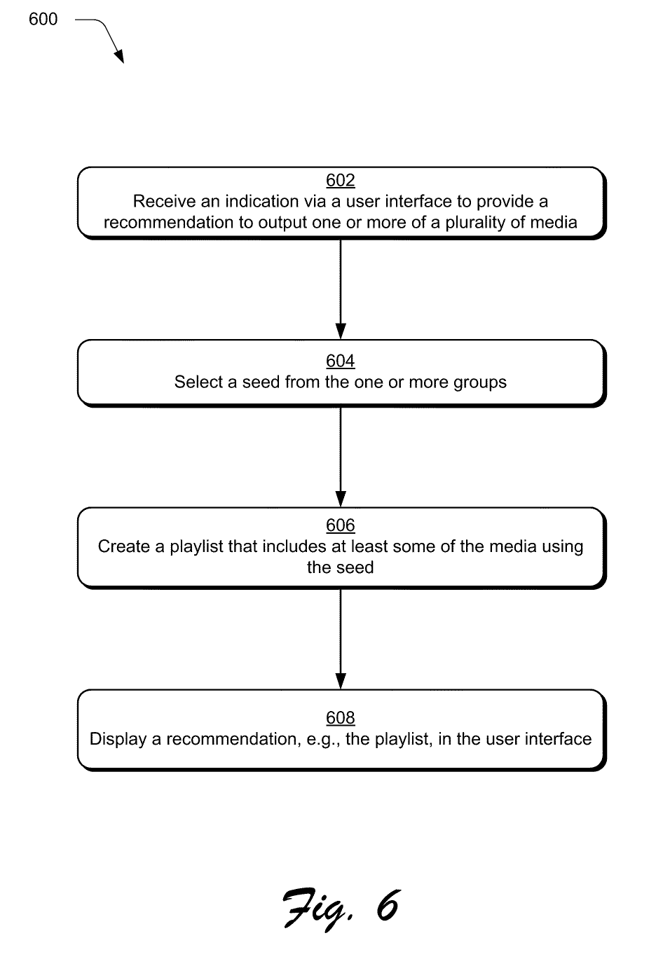

The media module 108 is also illustrated as including a seed module 116 and a recommendation module 118. The seed module 116 is representative of functionality of the media module 108 to generate a “seed” that identifies one of more the media 110, such as through examination of the media 110 itself and/or metadata 120 that is associated with the media. The seed may act as a starting point of a user experience provided by the mobile media device 104 such that a user may enjoy an efficient playback experience that leverages the media 110. The seed may be generated in a variety of ways, such as through an inverse form of one or more similarity functions. Through use of the inverse form, different listening properties of the media 110 (e.g., moods) may be captured to provide a varied user experience that may leverage an increased variety of the media 110. Further discussion of seed generation may be found in relation to FIGS. 2 and 6.

The recommendation module 118 is representative of functionality of the media module 108 to provide a framework to make recommendations involving the media 110. The framework provided by the recommendation module 118 is flexible in that the framework may employ a variety of different similarity functions to generate a playlist having one or more items of recommended media 110. For example, the recommendation module 118 may leverage the seed provided by the seed module 116 as a basis to calculate similarity of other media to generate a playlist using a plurality of similarity functions.

For instance, the recommendation module 118 may employ voting techniques such that no particular similarity function employed by the framework of the module has an undue influence (either positive or negative) as a basis for calculating similarity between the media 110. Additionally, the voting technique may be leveraged with other techniques to arrive at a final calculation of how similar the media 110 is to each other. This similarity may then be used as a basis to support a variety of other functionality, such as to generate a playlist. Although use of the seed from the seed module 116 has been described, functionality of the recommendation module 118 may also be implemented separately without the seed, e.g., to form one or more recommendations using the previously described framework. Further discussion of media recommendations may be found in relation to FIGS. 3, 4, and 7.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the media techniques described below are platform-independent, meaning that the techniques may be implemented on a variety of commercial computing platforms having a variety of processors.

FIG. 2 depicts a system 200 in an example implementation in which the seed module 116 is shown in greater detail. The mobile media device 104 in this example is illustrated as having a processor 202 and memory 204. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computer, may include, but are not limited to, quantum computing, optical computing, mechanical computing (e.g., using nanotechnology), and so forth. Additionally, although a single memory 204 is shown, a wide variety of types and combinations of memory may be employed, such as random access memory (RAM), hard disk memory, removable medium memory, and other types of computer-readable storage media.

The seed module 116 is illustrated as being executed on the processor 202 and is storable in memory 204. The seed module 116 is further illustrated as including a grouping module 206 that is representative of functionality to form one or more groups 208 of similar media 110. As illustrated, the grouping module 206 may employ a similarity function 210 (which may be representative of one or more similarity functions) to locate groups of the media 110 that have similar characteristics. Thus, each group formed using the similarity function 210 shares characteristics that are common to the group.

The seed module 116 may also employ an inverse form of a similarity function 212 (which may be the same as or different from the similarity function 210) to locate media that is dissimilar. For example, the inverse form of the similarity function 212 may be used to locate media 110 that is dissimilar in order to identify different kinds of listening properties within the media 110. In this way, groups 208 may be generated that describe similar and dissimilar media. For instance, one of the groups may reference media 110 that is “Rock” themed based on similarity (e.g., to a seed) and another one of the groups 208 may reference media 110 based on dissimilarity to the “Rock” themed group, such as ballads.

Metadata information may then be leveraged by the metadata analysis module 214 to “narrow down” a selection from the groups 208. For example, the metadata 120 may include a variety of different types of metadata 120, examples of which include media metadata 216 and user metadata 218. Media metadata 216 describes the media 110 itself, such as an artist, an album, a release date, a publisher, run time, a rating, and so on.

User metadata 218 describes a user's interaction with media, such as the media 110 of the mobile media device 104 and/or other media and thus may be considered a profile of the user. For example, the user metadata 218 may describe a play count, describe a time of day when the media 110 was played, what media 110 was played sequentially “with” particular items of the media 110 (e.g., which song preceded or followed song playback), which media 110 was included in a playlist by a user (and if so, how often), how the media 110 was obtained (e.g., download vs. “ripping”), when the media was obtained by the mobile media device 104 (e.g., when was the media 110 was caused to be downloaded over the network 106 by a user of the mobile media device 104 from the media provider 102), which of the media 110 was shared by a user of the mobile media device 104 with another user, and so on.

The metadata analysis module 214 of FIG. 2 is illustrated as being used to examine the metadata 120 associated with media 110 in the groups 208 to identify a seed 220 from each of the groups 208. The seed 220 may be used as a recommendation itself and/or to make additional recommendations through further processing by the recommendation module 118, further discussion of which may be found in relation to the following figure.

FIG. 3 depicts a system 300 in an example implementation in which the recommendation module 118 of FIG. 1 is shown in greater detail. The recommendation module 118 is illustrated as including a plurality of similarity functions 302, 304, 306. Although three similarity functions 302-306 are shown for clarity in the figure, it should be readily apparent that the recommendation module 118 is extensible and may support a variety of different numbers of similarity functions, e.g., from one to “N.”

Each of the similarity functions 302-306 is illustrated as including a respective threshold 308, 310, 312. The thresholds 308, 310, 312 (which may be the same or different, one to another) may be used in conjunction with a voting technique to determine whether the respective similarity functions 302, 304, 306 are to cast a respective vote 314, 316, 318. Although scalars are described as examples, these techniques may also employ non-scalar functions, e.g., vectors and so on.

For example, each of the similarity functions 302, 304, 306 may calculate a respective similarity value 320, 322, 324, e.g., through comparison of one item of media 110 with another. When the similarity values 320, 322, 324 indicate a relatively high likelihood of similarity based on comparison with the respective thresholds 308, 310, 312, a vote is assigned for the respective similarity function 302, 304, 306. Thus, a number of votes assigned to a media item may be used to quantify similarity of the media 110 and thus may provide a basis to form a preliminary ranking of the media 110 based on similarity by the ranking module 326.

Additional ranking techniques may also be employed by the ranking module 326. For example, the ranking module 326 may use the votes to arrive at an initial ranking of the media based on similarity. The ranking module 326 may then use the similarity values 320, 322, 324 to rank the items of media 110 that have a matching number of votes. For example, the recommendation module 118 may apply different weights to the similarity values 320, 323, 324 to arrive at a similarity total. This total may then be used to rank the media that has been assigned a matching number of votes, e.g., media that has been assigned 3 votes, 2 votes, 1 vote, or 0 votes in the illustrated example. Thus, the weights may be assigned and reassigned to affect how the media is ranked within a cluster with the votes 314-318 specifying which media 110 is included in the clusters.

The ranking module 326 may also employ a variety of other techniques with the rankings to arrive at a recommendation, examples of which are illustrated as a probability function 328 and an ordering function 330. The probability function is representative of functionality to select media to form a playlist 332. In an implementation, the probability function 328 is configured to have a higher probability of selecting from the media 110 at a top of the ranking than from a bottom of the ranking. In other words, the probability function 328 is configured to have a higher probability of selecting media 110 that is similar than dissimilar. In this way, the playlist 332 is more likely to have the media 110 arranged in different ways each time the playlist 332 is generated even though a same seed may be used each time.

The ranking module 326 is also illustrated as including an ordering function 330 that is representative of functionality to order the media 110 to form the playlist 332. A variety of different techniques may be employed. For example, the ordering function 330 may accept as an input the output of the probability function 328 and reorder sequential media 110 that has a matching artist. A variety of other examples are also contemplated, such as for reordering of media from the same albums from the same artist (e.g., when each of the media is from the same artist).

FIG. 4 illustrates a system 400 in an example implementation in which a user interface is used to configure which similarity functions are employed by the recommendation module 118 of FIG. 3. The media provider 102 in this example is illustrated as outputting a user interface 502 that includes a display of a plurality of similarity functions, 504, 506, 508, 510.

The first similarity function 504 describes a metadata function that is configured to perform metadata attribute analysis using multidimensional scaling. The second similarity function 506 describes a filtering function that is configured to use collaborative filtering to identify media that has a high co-occurrence in a community's playback usage. The third similarity function 508 references the use of digital signal processing and the fourth similarity function 510 describes a style filter 510 that describes use of detailed metadata to determine similarity, e.g., styles, textual analysis of artist information, and so on. A variety of other similarity functions may also be described in the user interface 502.

The user interface 502 also includes functionality to specify whether the referenced similarity function is to be used in making the recommendation (e.g., the “Use” column) and to assign a weight to the similarity functions (e.g., the “Weight” column) for use in ranking the media 110 as previously described.

The user interface 502 further includes an option to add/remove 512 similarity functions for use by the recommendation module 118. For example, selection of the add/remove 512 portion of the user interface 502 may provide an option to import new similarity functions and/or remove similarity functions.

Information that describes changes made may through interaction with the user interface 502 may then be communicated via the network 106 to the mobile media device 104, e.g., as an update. In this way, the recommendation module 118 may be flexible to leverage new similarity functions and/or remove similarity functions that are subsequently determined to be undesirable. Further, interaction with the user interface 502 may adjust the effect each of these functions has on the ranking, e.g., by adjusting weights, which may then be exposed for access over the network 106. A variety of other examples are also contemplated, such as through output of the user interface 502 on the mobile media player 104 itself.

Example Procedures

The following discussion describes user interface techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the systems 200, 300, 400 of FIGS. 2, 3, and 4.

FIG. 5 depicts a procedure 500 in an example implementation in which pre-processing is performed to form groups that may serve as a basis for making media recommendations. Output of a plurality of audio content by a computer is monitored and data is collected that describes the monitoring (block 502). The monitoring may be performed in a variety of ways, such as through local execution of a module on the computer and/or remotely by determining which media was communicated (e.g., streamed) to the computer.

A set of dissimilar candidates is calculated for a plurality of media using a similarity function in which the set of dissimilar candidates describe media that is dissimilar in comparison with other media included in the plurality of media (block 504). For example, the seed module 116 may examine a list of media that is often selected for playback by a user and determine groups of media 110 that are dissimilar to the user-selected media.

One or more groups are formed from the plurality of media having similar characteristics based at least in part on the set of dissimilar candidates (block 506). Continuing with the previous example, after the seed module 116 determines which media is dissimilar, the seed module 116 may then form groups of the dissimilar media. Groups may also be formed of media that is similar to the user-selected media. In this way, the groups may correspond to a wide range of styles and moods.

Data is cached that describe the one or more groups (block 508). For example, the data may be cached locally on the mobile media device 104 and/or remotely over the network, e.g., by the media provider 102. The cached data may then be used to increase efficiency of generating recommendations thereby improving an overall user experience, further discussion of which may be found in relation to the following figure.

FIG. 6 depicts a procedure 600 in an example implementation in which a seed is formed from data cached using the procedure 500 of FIG. 5. An indication is received via a user interface to provide a recommendation to output one or more of a plurality of media (block 602). For example, the indication may involve navigation to a page in a user interface that is to include the recommendations, selection of a button to generate recommendations, and so on.

A seed is selected from the one or more groups (block 604). The seed may be selected to impart a variety of different functionality. For example, selection of the seed may be based, at least in part, on current conditions for playback such as a time of day the recommended media is to be output. For instance, a user of the mobile media device 104 may select certain media 110 at different times of day to reflect a changing mood. By leveraging the user metadata 218 by the seed module 116, media 110 may be selected from the groups that correspond to this mood. Additionally, because the groups were cached in this example the selection of the media may be performed in a timely manner yet still leverage the current conditions to increase the likelihood that the selected media is desired by a user of the mobile media device 104. Although use of a time of day has been described, it should be readily apparent that a wide variety of the metadata 120 (e.g., the media metadata 216 and/or user metadata 218) may be employed without departing from the spirit and scope thereof.

A playlist is created using the seed that includes at least some of the media (block 606) and a recommendation, e.g., the playlist, is displayed in the user interface (block 608). For example, a seed may be selected from each of the groups and output in the user interface 112. Selection of the seed may cause output of the represented media as well as generation of a playlist to determine “what is played next.” The playlist may be generated in a variety of ways, an example of which is discussed in relation to the following figure.

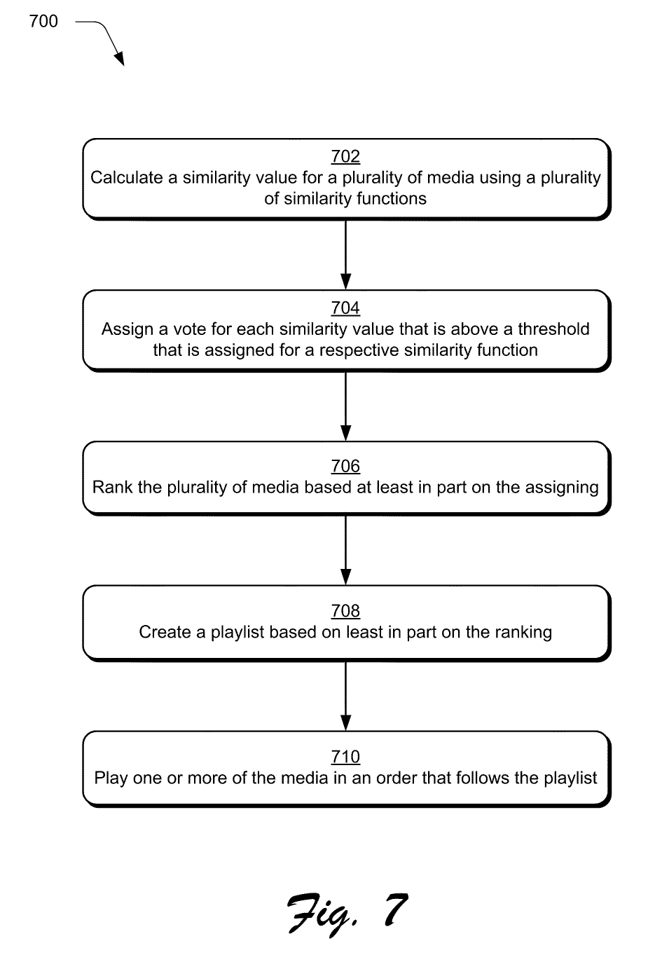

FIG. 7 depicts a procedure 700 in an example implementation in which a playlist is formed using a framework of FIGS. 3 and 4 by a seed generated using the system 200 of FIG. 2. A similarity value for a plurality of media is calculated using a plurality of similarity functions (block 702). For example, each of the similarity functions 302-306 may be used to calculate a respective similarity value 320-324.

A vote is assigned for each similarity value that is above a threshold assigned for a respective similarity function (block 704). Continuing with the previous example, if the similarity values 320-324 are “above” a respective threshold 308-312 a respective vote 314-318 is assigned. In other words, if the similarity values 320-324 indicate that the similarity of the media at least meets the threshold 308-312 for that function, the respective similarity function 302-306 “votes” that the media are similar.

The plurality of media is ranked at least in part based on the assigning (block 706) of the votes. As previously described, an initial ranking may be formed by the ranking module 326 such that media that has the greatest number of votes is ranked at the “top” of the ranking. Media that has a matching number of votes may then be ranked within that subset (i.e., media having a same number of votes) using a final value calculated from the similarity values 320-324. In an implementation, at least two of the similarity values 320-324 are given different weights to calculate the final value. Thus, each of the similarity functions may have an equal amount of “say” in calculating the initial ranking using the votes and an unequal amount of “say” in calculating ranking within subsets of the initial ranking that have a matching number of votes. In this way, recommendations may be generated to leverage a wide variety of similarity functions.

A playlist is created based on least in part on the ranking (block 708) of the plurality of media. As previously described in relation to FIG. 3, for instance, the ranking module 326 may employ the probability function and/or the ordering function 330 to finish generation of the playlist 332. One or more of the media may then be played in an order that follows the playlist (block 710), e.g., output of the media 110 by the mobile media device 104.

FIG. 8 depicts a procedure 800 in an example implementation in which a media playlist is generated to reference media that is remote to a computer. A communication is formed, for transmission via a network to a media provider, to request data that describes media that is available for streaming from the media provider (block 802). A playlist is then created that references media that are available for streaming via the network to the computer from the media provider (block 804). Media included in the playlist may then be received at the computer via streaming from the media provider (block 806).

For example, the playlist may be created based on a seed that is local to the computer, e.g., a song stored in memory 204 of the mobile media device 104. In another example, the playlist may be created based on a seed that is remote to the computer, e.g., media that is available from the media provider 102 via the network 106. For instance, the mobile media device 104 may navigate to the media provider 102 using browser functionality and select a particular item of media that is displayed in a webpage of the media provider 102 for use as the seed. A variety of other instances are also contemplated. For instance, the playlist may be created based at least on part on an indication of a particular artist, genre, album, and so on and thus may also be used as a basis for selecting media to be included in the playlist.

The indications may also identify a variety of other considerations that may be taken into account to create the playlist. One such indication is to include media that is not available locally on the computer, e.g., the mobile media device 104. This media may then be streamed from the media provider 102 via the network 106 for output by the computer, e.g., in real time and/or stored for later output. In this way, the playlist may be used to expand a user's experience with media beyond that which is available locally at the computer. In an implementation, the communication may also be used to specify how much media is to be used that is local or remote, e.g., such as by specifying a number of items, an amount of time, percentages, and so on. Therefore, the user may be able to provide input as to “how much” this experience is to be expanded beyond the media that is available locally on the computer, e.g., the mobile media device 104.

Another such basis for forming the playlist may include access rights of a user associated with the computer to media of the media provider 102. For instance, the user may have a subscription to certain media from the media provider 102 and therefore media may be selected that is accessible because of this subscription. A variety of other considerations are also contemplated, such as to specify a duration for the playlist, how often the playlist is recreated to update the playlist, and so on. These considerations may then be used to generate the playlist, further discussion of which may be found in relation to the following figure.

FIG. 9 depicts a system 900 in an example implementation in which the mobile media device 104 of FIG. 1 is illustrated as outputting a playlist 902. The playlist 902 as displayed on the mobile media device 104 includes a plurality of media 904, 906, 906. In this instance, a user associated with the mobile media device 104 does not have a subscription to media provided by the media provider 102. However, the playlist still includes references to this media and provides an option to make the media available, an example of which is illustrated for media 906 that includes an option “Try a Free Pass.” Selection of the option may provide the user with a limited subscription to access the media, e.g., for 14 days. In an implementation, the user is able to hear a sample of the media 906 by “clicking” on the name of the media such that a portion of the media is output, although another portion of the media is not. Thus, media may also be referenced in the playlist that is not directly accessible. Although a subscription has been described in this example, it should be apparent that a wide variety of purchase options may be employed without departing from the spirit and scope thereof, such as to purchase individual items of media for download. Additionally, although creation of the playlist has been described as happening at the mobile media device 104, the playlist may be created by a variety of different entities, such as by media provider 102 or other computer, e.g., a third-party stand-alone provider.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a computer, the method comprising:
forming a communication, for transmission via a network to a media provider, to request data that describes media that is available for streaming from the media provider; and
creating the playlist based at least in part on media that is available locally on the computer and the data received from the media provider such that the playlist references one or more of the media that are available for streaming from the media provider.

2. A method as described in claim 1, wherein the one or more of the media that are available for streaming from the media provider in the playlist are not available locally at the computer.

3. A method as described in claim 1, wherein the creating is performed based on an indication that specifies how often the playlist is to be created.

4. A method as described in claim 1, wherein the creating is performed based on an indication that specifies how much of the media from the media provider is to be used and how much media from the computer is to be used to create the playlist.

5. A method as described in claim 1, the creating is performed based on an indication that specifies a duration for the playlist.

6. A method as described in claim 1, wherein the creating is performed based on identification in the communication of the particular one of the plurality of media available for streaming from the media provider.

7. A method as described in claim 1, wherein the creating is performed based on identification in the communication of an album that includes the particular one of the plurality of media.

8. A method as described in claim 1, wherein the creating is performed based on identification in the communication of an artist that corresponds to the particular one of the plurality of media.

9. A method as described in claim 1, wherein the creating is performed based on identification in the communication of a genre that corresponds to the particular one of the plurality of media.

10. A method as described in claim 1, wherein the playlist includes at least one item of media that is available locally on the computer.

11. A method implemented by one or more computers of a media provider, the method comprising:
receiving a communication via a network from a computer; and
responsive to the communication, sending data to the computer that references media that is available for streaming to the computer for use in creating a playlist by the computer that references media that is available for streaming via the network to the computer from the media provider.

12. A method as described in claim 11, wherein the sending includes locating the media that is available for streaming via the network to the computer based on a subscription of a user associated with the computer.

13. A method as described in claim 11, wherein at least one item of the media that is available for streaming via the network from the media provider is referenced in the playlist to enable output of a portion of the at least one item of media but not another portion of the at least one item of media.

14. A method as described in claim 13, wherein the portion of the least one item of media that is enabled for output is a sample.

15. A method as described in claim 11, wherein at least one item of the media that is available for streaming via the network from the media provider is referenced in the playlist to enable purchase of the least one item of media.

16. A method as described in claim 11, wherein the sending is based at least in part on an indication that specifies how much of the media from the media provider is to be used and how much of the media from the computer is to be used to create the playlist.

17. A method as described in claim 11, wherein the playlist includes at least one item of media that is available locally on the computer.

18. One or more computer-readable storage media comprising instructions that are executable on a computer to create a playlist that includes media that is to the computer remotely via a network connection and cause the playlist to be output by the computer so the media in the playlist that is not available locally on the computer is streamed to the computer via the network connection.

19. The one or more computer-readable media as described in claim 18, wherein playlist includes the media that is available for streaming via the network to the computer based on a subscription of a user associated with the computer

20. The one or more computer-readable media as described in claim 18, wherein at least one item of the media that is available for streaming via the network is referenced in the playlist to enable purchase of the least one item of media
